(19) United States
(12) Patent Application Publication
(10) Pub. No.: US 2013/0304943 A1
(43) Pub. Date: Nov. 14, 2013

(54) METHOD FOR BROADCAST PROCESSING WITH REDUCED REDUNDANCY

(71) Applicants: Vidyadhar C. Pinglikar, Pune (IN); Prasad Ramchandra Kadam, Pune (IN); Shankar T. More, Pune (IN)

(72) Inventors: Vidyadhar C. Pinglikar, Pune (IN); Prasad Ramchandra Kadam, Pune (IN); Shankar T. More, Pune (IN)

(73) Assignee: LSI CORPORATION, Milpitas, CA (US)

(21) Appl. No.: 13/469,141

(22) Filed: May 11, 2012

(51) Int. Cl. G06F 3/00

(52) U.S. Cl. 710/15

(57) ABSTRACT

A method for broadcast forwarding in a SAS topology having a zoned portion of a service delivery system (ZPSDS) is disclosed. The ZPSDS includes at least a first zoning expander and a second zoning expander. The method includes originating a broadcast primitive on the first zoning expander; forwarding solely the broadcast primitive to the second zoning expander from the first zoning expander; initiating a discovery process from the second zoning expander upon receiving the broadcast primitive; and generating a source zone group list upon completion of the discovery process.

### TECHNICAL FIELD

The present invention relates to the field of data processing and particularly to a method for broadcast processing with reduced redundancy.

### BACKGROUND

Serial Attached SCSI (SAS) is a computer bus used to move data to and from computer storage devices. SAS may be utilized for connecting large groups of devices and therefore may need to be segregated and managed by zones. SAS protocol defines the function of an expander device, which is a part of the service delivery system and facilitates communication between various devices.

SAS zoning provides functionality for traffic segregation, resource flexibility, controlled resource sharing, topology control, and protection against unauthorized access. SAS zoning may utilize a unique ID number of each expander PHY to provide a secure method of managing SAS devices. A user may assign expander ports to zone groups, and any device attached to one of the ports may become a part of that respective zone group. For instance, by default, all devices within a zone group may interact with each other. The permission table in the expander may control access between devices in different zone groups.

Logical grouping allows zoning access within and between controlled zone groups. A zoned portion of a service delivery system (ZPSDS) may include a group of zoning-enabled expanders that cooperate to control access between PHYs. An end device does not need any special features to operate within a zoned SAS domain, and the zoning expander controls whether an end device in a zone can communicate with other end devices in the same domain.

SAS protocol may utilize broadcast primitives to communicate with various devices. A broadcast primitive allows different types of messages to be transmitted, but the primitive itself does not carry any additional information. Currently, broadcast processing in a SAS topology with zoning enabled requires SAS Management Protocol (SMP) ZONED BROADCAST to be sent to the expanders that are a part of the ZPSDS. That is, if the expander port's INSIDE ZPSDS bit is set to one, then the broadcast propagation process (or BPP, an object within an expander function that manages broadcasts) shall request that the SMP initiator port establish a connection on at least one PHY in the expander port to the SMP target port of the attached expander device and transmit an SMP ZONED BROADCAST request specifying the source zone group(s).

Sending SMP ZONED BROADCAST involves sending of SMP frames. For sending frames in SAS topology, connections have to be opened and maintained, which introduced considerable amount of overhead. In large topology, transient I/O transfer performance may be compromised when SMP ZONED BROADCASTs are forwarded. Therein lies the need to provide a method for broadcast processing with reduced overhead.

### SUMMARY

Accordingly, an embodiment of the present disclosure is directed to a method for broadcast forwarding in a SAS topology having a zoned portion of a service delivery system (ZPSDS). The ZPSDS includes at least a first zoning expander and a second zoning expander. The method includes originating a broadcast primitive on the first zoning expander; forwarding solely the broadcast primitive to the second zoning expander from the first zoning expander; initiating a discovery process from the second zoning expander upon receiving the broadcast primitive; and generating a source zone group list upon completion of the discovery process.

A further embodiment of the present disclosure is directed to a SAS topology. The SAS topology includes a zoned portion of a service delivery system (ZPSDS). A first zoning expander and a second zoning expander are configured as a part of the ZPSDS. In an event of broadcast forwarding, the first zoning expander is configured to originate a broadcast primitive and forward solely the broadcast primitive to the second zoning expander. The second zoning expander is configured to initiate a discovery process upon receiving the broadcast primitive and generating a source zone group list upon completion of the discovery process.

Additionally, if the SAS topology includes a third expander, the second zoning expander is configured to forward solely the broadcast primitive to the third expander in the event of broadcast forwarding. Furthermore, if the third expander is a zoning expander and is a part of the ZPSDS, then the third expander is configured to: initiate a discovery process upon receiving the broadcast primitive; and generate a source zone group list upon a completion of the discovery process. Otherwise, if the third expander is not a part of the ZPSDS, then the third expander is configured to initiate a discovery process upon receiving the broadcast primitive.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is a block diagram illustrating a SAS topology and a broadcast forwarding process handled in the SAS topology;

FIG. 2 is a block diagram illustrating a SAS topology and a broadcast forwarding process handled in the SAS topology in accordance with the present disclosure; and

FIG. 3 is a flow diagram illustrating a method for broadcast forwarding in a SAS topology in accordance with the present disclosure.

### DETAILED DESCRIPTION

Reference will now be made in detail to the presently preferred embodiments of the invention, examples of which are illustrated in the accompanying drawings.

The present disclosure is directed to a method for broadcast processing/forwarding with reduced redundancy. Instead of sending SMP ZONED BROADCASTs to the zoning-enabled expanders that are a part of the ZPSDS, only Broadcast (Change) primitives are sent to these expanders. Since the information provided by the SMP ZONED BROADCAST can also be computed in the expander itself at runtime while performing the discovery process, sending SMP ZONED BROADCASTs to such expanders is therefore deemed redundant and wastes system resources. In accordance with the present disclosure, broadcast primitive forwarding is sufficient to forward broadcast change information correctly to required devices in the SAS domain, and the expanders are configured to generate the source zone group list themselves upon receiving the broadcast primitives. Therefore, the method in accordance with the present disclosure effectively eliminates the need for SMP ZONED BROADCAST forwarding, reducing SMP traffic and the overhead of broadcast forwarding.

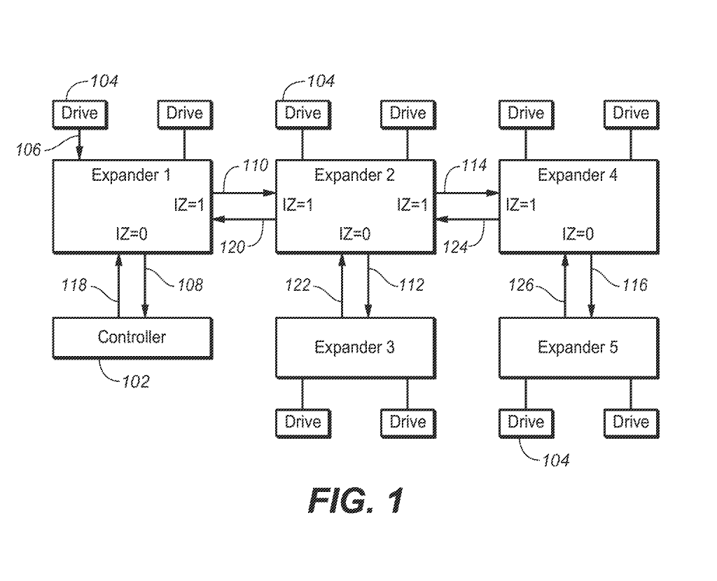

Referring to FIG. 1, a block diagram illustrating the existing process flow for broadcast processing/forwarding in an exemplary SAS topology 100 is shown. The exemplary SAS topology 100 may include a controller 102 in communication with a plurality of storage devices (drives) 104 via one or more expanders. This particular exemplary SAS topology 100 may include five expanders. Among them, expanders 1, 2 and 4 are zoning expander devices with zoning enabled and expanders 3 and 5 are not.

According to the existing process flow for broadcast forwarding, when a broadcast change is originated on an expander, SMP ZONED BROADCAST needs to be forwarded to all IZPSDS links. Such a SMP ZONED BROADCAST contains the source zone group list along with the broadcast type. When an expander receives SMP ZONED BROADCAST, this expander needs to forward broadcast on the destination PHYs for which zone group permission is accessible with one or more of the zone groups in the received source zone group list. It also has to forward SMP ZONED BROADCAST over all IZPSDS links except the source IZPSDS link. This is described in the following example.

Referring to FIG. 1, suppose Broadcast (Change) is originated on Expander 1 in step 106. Step 108 indicates that the Broadcast (Change) primitive shall be forwarded to the controller 102 from Expander 1. Step 110 indicates that SMP ZONED BROADCAST shall be sent to Expander 2 from Expander 1. Step 112 indicates that the Broadcast (Change) primitive shall be forwarded to Expander 3 from Expander 2. Step 114 indicates that the SMP ZONED BROADCAST shall be sent to Expander 4 from Expander 2. Step 116 indicates that the Broadcast (Change) primitive shall be forwarded to Expander 5 from Expander 4.

Subsequently, the controller 102 shall initiate the discovery process in step 118 on the port on which the Broadcast (Change) primitive was received. Step 118 may be carried out any time after step 108. In addition, Expander 2 (and Expander 4) shall initiate the discovery process in step 120 (and step 124) on the port on which SMP ZONED BROADCAST was received. Steps 120 and 124 may be carried out any time after steps 110 and 114, respectively. Furthermore, Expander 3 (and Expander 5) shall initiate the discovery process in step 122 (and step 126) on the port on which the Broadcast (Change) primitive was received. Steps 122 and 126 may be carried out any time after steps 112 and 116, respectively.

It has been observed, however, that the same source zone group list provided by the SMP ZONED BROADCAST can be generated by the discovery process in the zoning expanders. For instance, this information may be generated from zone group and PHY change count information in discover SMP response instead of receiving this information through SMP ZONED BROADCAST. In addition, as this information is present and may be retrieved through normal discovery process, no additional overhead of SMP traffic is required.

Therefore, in accordance with the present disclosure, forwarding a broadcast primitive is sufficient over the IZPSDS link instead of sending SMP ZONED BROADCASTs. More specifically, when a broadcast primitive is received at a zoning expander (i.e., an expander within ZPSDS), the discovery module in such a zoning expander may generate the source zone group list. This information derived by the discovery module may then be used by that zoning expander to forward the broadcast primitives to the devices which are not in the ZPSDS. This is described in the following example.

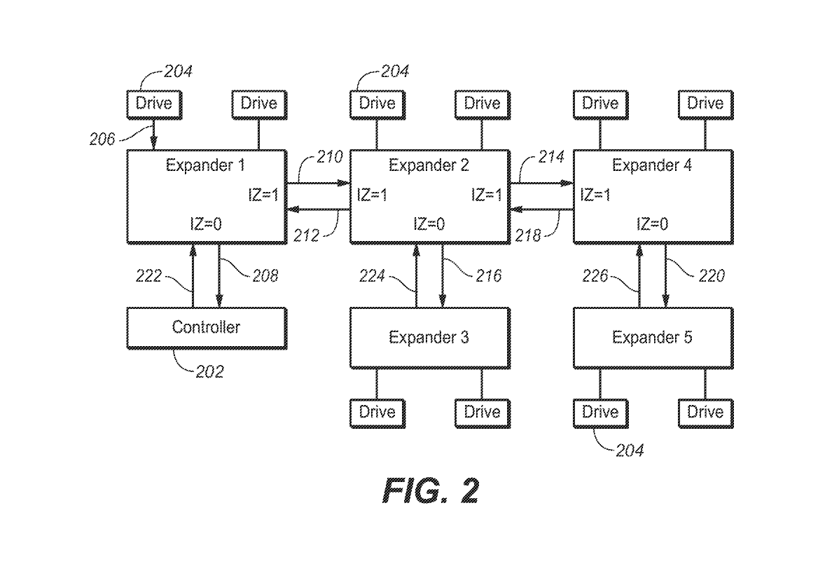

Referring to FIG. 2, suppose Broadcast (Change) is originated on Expander 1 in step 206. Step 208 indicates that the Broadcast (Change) primitive shall be forwarded to the controller 202 from Expander 1. Step 210 indicates that only Broadcast (Change) primitive, without SMP ZONED BROADCAST, is sent to Expander 2 from Expander 1. Upon receiving the Broadcast (Change) primitive, Expander 2 shall initiate the discovery process in step 212 on the port on which the Broadcast (Change) primitive was received. Expander 2 may subsequently generate the source zone group list after completing the discovery process.

Step 214 indicates that only Broadcast (Change) primitive, without SMP ZONED BROADCAST, is sent to Expander 4 from Expander 2. In addition, as indicated in step 216, Expander 2 shall also forward the Broadcast (Change) primitive to Expander 3 based on the permissions available between source zone group list prepared by Expander 2 and the zone group of PHY to which expander 3 is attached.

Upon receiving the Broadcast (Change) primitive from Expander 2, Expander 4 shall initiate the discovery process in step 218 on the port on which the Broadcast (Change) primitive was received. Expander 4 shall subsequently generate the source zone group list after completing the discovery process. In addition, as indicated in step 220, Expander 4 shall also forward the Broadcast (Change) primitive to Expander 5 based on the permissions available between source zone group list prepared by Expander 4 and the zone group of PHY to which expander 5 is attached.

Subsequently, the controller 202 shall initiate the discovery process in step 222 on the port on which the Broadcast (Change) primitive was received. Step 222 may be carried out any time after step 208. In addition, Expander 3 (and Expander 5) shall initiate the discovery process in step 224 (and step 226) on the port on which the Broadcast (Change) primitive was received. Steps 224 and 226 may be carried out any time after steps 216 and 220, respectively.

It is understood that the SAS topology and the process flow describe above are merely exemplary. Furthermore, it is understood that specific order or hierarchy of steps in the process flow describe above are also merely exemplary, that the specific order or hierarchy of steps in the process flow may be rearranged while remaining within the scope of the present invention.

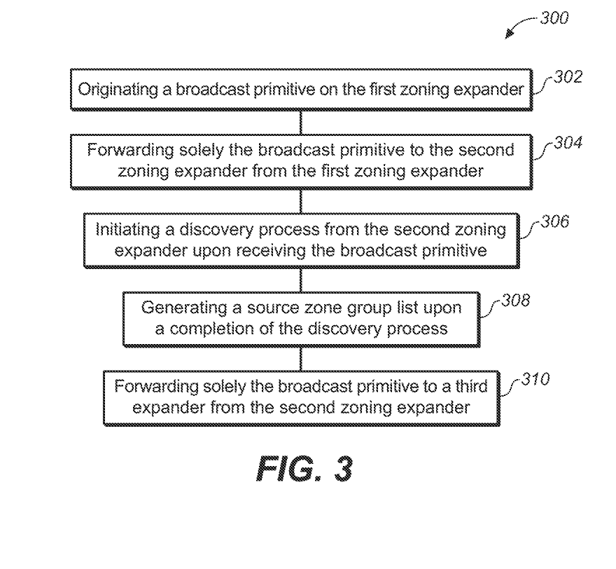

FIG. 3 shows a flow diagram illustrating a method 300 for broadcast forwarding in a SAS topology in accordance with the present disclosure. The SAS topology shall include at least two zoning expanders. A broadcast primitive shall be originated on the first zoning expander in step 302. This broadcast primitive shall then be forwarded to the second zoning expander from the first zoning expander in step 304. As previously described, even though the second expander is a zoning expander (i.e., within ZPSDS), SMP ZONED BROADCAST is not forwarded to the second zoning expander. Instead, as depicted in step 306, the second zoning expander is configured to initiate a discovery process upon receiving the broadcast primitive. The second zoning expander may then generate the source zone group list in step 308 upon completion of the discovery process.

It is contemplated that the SAS topology may include additional expanders. For instance, the second zoning expander may forward the broadcast primitive to a third expander. If the third expander is a part of ZPSDS, then the third expander shall initiate a discovery process upon receiving the broadcast primitive and generate a source zone group list accordingly. Otherwise, if the third expander is outside of ZPSDS, then the third expander may initiate a discovery process upon receiving the broadcast primitive and proceed as normal.

It is to be understood that the present disclosure may be conveniently implemented in forms of a software package. Such a software package may be a computer program product which employs a computer-readable storage medium including stored computer code which is used to program a computer to perform the disclosed function and process of the present invention. The computer-readable medium may include, but is not limited to, any type of conventional floppy disk, optical disk, CD-ROM, magnetic disk, hard disk drive, magneto-optical disk, ROM, RAM, EPROM, EEPROM, magnetic or optical card, or any other suitable media for storing electronic instructions.

It is understood that the specific order or hierarchy of steps in the foregoing disclosed methods are examples of exemplary approaches. Based upon design preferences, it is understood that the specific order or hierarchy of steps in the method can be rearranged while remaining within the scope of the present invention. The accompanying method claims present elements of the various steps in a sample order, and are not meant to be limited to the specific order or hierarchy presented.

It is believed that the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A method for broadcast forwarding in a SAS topology having a zoned portion of a service delivery system (ZPSDS), the ZPSDS including at least a first zoning expander and a second zoning expander, the method comprising:
originating a broadcast primitive on the first zoning expander;
forwarding solely the broadcast primitive to the second zoning expander from the first zoning expander;
initiating a discovery process from the second zoning expander upon receiving the broadcast primitive; and
generating a source zone group list upon completion of the discovery process.

2. The method of claim 1, further comprising:
forwarding solely the broadcast primitive to a third expander from the second zoning expander.

3. The method of claim 2, wherein the third expander is a zoning expander and is a part of the ZPSDS, and the third expander is configured to: initiate a discovery process upon receiving the broadcast primitive; and generate a source zone group list upon completion of the discovery process.

4. The method of claim 2, wherein the third expander is not a part of the ZPSDS, and the third expander is configured to initiate a discovery process upon receiving the broadcast primitive.

5. The method of claim 1, wherein the discovery process initiated from the second zoning expander is initiated on a port on which the broadcast primitive was received.

6. The method of claim 1, wherein the broadcast primitive is Broadcast (Change) primitive.

7. A SAS topology, comprising:
a zoned portion of a service delivery system (ZPSDS);
a first zoning expander and a second zoning expander configured as part of the ZPSDS;
the first zoning expander configured to originate a broadcast primitive and forward solely the broadcast primitive to the second zoning expander in an event of broadcast forwarding;
the second zoning expander configured to initiate a discovery process upon receiving the broadcast primitive and generating a source zone group list upon completion of the discovery process.

8. The SAS topology of claim 7, further comprising:
a third expander, wherein the second zoning expander is configured to forward solely the broadcast primitive to the third expander in the event of broadcast forwarding.

9. The SAS topology of claim 8, wherein the third expander is a zoning expander and is a part of the ZPSDS, and the third expander is configured to: initiate a discovery process upon receiving the broadcast primitive; and generate a source zone group list upon a completion of the discovery process.

10. The SAS topology of claim 8, wherein the third expander is not a part of the ZPSDS, and the third expander is configured to initiate a discovery process upon receiving the broadcast primitive.

11. The SAS topology of claim 7, wherein the discovery process initiated from the second zoning expander is initiated on a port on which the broadcast primitive was received.

12. The SAS topology of claim 7, wherein the broadcast primitive is Broadcast (Change) primitive.

13. A method for broadcast forwarding in a SAS topology having a zoned portion of a service delivery system (ZPSDS), the ZPSDS including at least a first zoning expander and a second zoning expander, the method comprising:
originating a broadcast primitive on the first zoning expander;
forwarding solely the broadcast primitive to the second zoning expander from the first zoning expander;
initiating a discovery process from the second zoning expander upon receiving the broadcast primitive;
generating a source zone group list upon completion of the discovery process; and
forwarding solely the broadcast primitive to a third expander from the second zoning expander.

14. The method of claim 13, wherein the third expander is a zoning expander and is a part of the ZPSDS, and the third expander is configured to: initiate a discovery process upon receiving the broadcast primitive; and generate a source zone group list upon completion of the discovery process.

15. The method of claim 13, wherein the third expander is not a part of the ZPSDS, and the third expander is configured to initiate a discovery process upon receiving the broadcast primitive.

16. The method of claim 13, wherein the discovery process initiated from the second zoning expander is initiated on a port on which the broadcast primitive was received.

17. The method of claim 13, wherein the broadcast primitive is Broadcast (Change) primitive.
